(19) United States
(12) Patent Application Publication
(10) Pub. No.: US 2026/0173230 A1
(43) Pub. Date: Jun. 18, 2026

(54) Pulse Dimming for a Light Emitting Diode Driver

(71) Applicant: TEXAS INSTRUMENTS INCORPORATED, Dallas, TX (US)

(72) Inventors: Yichao Tang, Bangalore (IN); Zhengyang Wu, Hangzhou (CN); Jiana Lou, Shanghai (CN); Jianwei Lin, Hefei (CN)

(21) Appl. No.: 18/981,831

(22) Filed: Dec. 16, 2024

(51) Int. Cl. H05B 45/10; H05B 45/325; H05B 45/375; H05B 45/38; H05B 47/165

(52) U.S. Cl. CPC H05B 45/10; H05B 45/325; H05B 45/375; H05B 45/38; H05B 47/165

(57) ABSTRACT

Transistor control logic has first and second inputs and an output. The output couples to a transistor's control terminal. A peak current detector has reference and sense inputs and an output. The peak current detector asserts a first signal at its output at a first logic state responsive to a sense signal exceeding a reference signal. A trigger latch has first and second inputs and an output. The first input of the trigger latch couples to the peak current detector's output. The output of the trigger latch is coupled to the transistor control logic's first input. The trigger latch asserts a third signal at the first logic state at the trigger latch's output responsive to the first signal at the output of the peak current detector being at the first logic state and a second signal at the trigger latch's second input being at a second logic state.

### BACKGROUND

A light emitting diode (LED) driver controls the brightness of light produced by LEDs. A technique for controlling the brightness level is through pulse width modulation (PWM) dimming. PWM dimming regulates the output current to the LEDs by chopping the current based on a PWM signal.

### SUMMARY

In one example, transistor control logic has first and second inputs and an output. The output couples to a transistor's control terminal. A peak current detector has reference and sense inputs and an output. The peak current detector asserts a first signal at its output at a first logic state responsive to a sense signal exceeding a reference signal. A trigger latch has first and second inputs and an output. The first input of the trigger latch couples to the peak current detector's output. The output of the trigger latch couples to the transistor control logic's first input. The trigger latch asserts a third signal at the first logic state at the trigger latch's output responsive to the first signal at the output of the peak current detector being at the first logic state and a second signal at the trigger latch's second input being at a second logic state.

In another example, an apparatus includes a trigger latch having a first input, a second input, and an output. The trigger latch is configured to assert a first signal at a first logic state at the output of the trigger latch in response to both a second signal at the first input of the trigger latch being at a second logic state and a third signal at the second input of the trigger latch being at the second logic state. A pulse feedforward circuit has an output. An error amplifier has first and second inputs and an output. A switch has a first switch terminal, a second switch terminal, and a control terminal. The first switch terminal is coupled to the output of the pulse feedforward circuit. The second switch terminal is coupled to the output of the error amplifier, and the control terminal of the switch is coupled to the output of the pulse feedforward circuit. A comparator has a first input, a second input, and an output. The first input of the comparator is coupled to the second switch terminal. The second input of the comparator is coupled to the second input of the error amplifier, and the output of the comparator is coupled to the first input of the trigger latch.

In yet another example, an apparatus includes a transistor having a control terminal. Transistor control logic has a first input, a second input, and an output. The output is coupled to the control terminal of the transistor. A peak current detector has a reference input, a sense input, a third input, and an output. The peak current detector is configured to assert a first signal at the output of the peak current detector at a first logic state in response to a sense signal at the sense input exceeding a reference signal at the reference input. A pulse feedforward circuit has an input and an output. The input of the pulse feedforward circuit is coupled to the reference input of the peak current detector. A switch has a first switch terminal, a second switch terminal, and a control terminal. The first switch terminal is coupled to the output of the pulse feedforward circuit. The second switch terminal is coupled to the third input. A trigger latch has a first input, a second input, a first output, and a second output. The first input of the trigger latch is coupled to the output of the peak current detector. The first output of the trigger latch is coupled to the first input of the transistor control logic. The second output of the trigger latch is coupled to the control terminal of the switch. The trigger latch is configured to assert a second signal at the first logic state at the first output of the trigger latch in response to both the first signal at the output of the peak current detector being at the first logic state and a third signal at the second input of the trigger latch being at a second logic state.

### BRIEF DESCRIPTION OF THE DRAWINGS

FIG. 1 is a diagram of a system which includes a microcontroller unit (MCU), an LED driver, a power stage circuit, and one or more LEDs, in an example.

FIGS. 2 and 3 are schematic diagrams of examples of the power stage circuit of FIG. 1.

FIGS. 4 and 5 are example waveforms illustrating the problem solved by the LED driver 120 described herein.

FIG. 6 is a schematic diagram of an example implementation of control logic usable in the LED driver of FIG. 1.

FIG. 7 is a schematic diagram of trigger latch usable in the control logic of FIG. 6, in an example.

FIG. 8 includes example waveforms illustrating pulse width modulation extension, in an example.

FIG. 9 is a schematic diagram of another example implementation of control logic usable in the LED driver of FIG. 1.

FIG. 10 is a schematic diagram of trigger latch usable in the control logic of FIG. 9, in an example.

FIG. 11 is a schematic diagram of a pulse feedforward circuit usable in the control logic of FIG. 9, in an example.

FIG. 12 is a schematic diagram of yet another example implementation of control logic usable in the LED driver of FIG. 1.

FIG. 13 is a schematic diagram of trigger latch usable in the control logic of FIG. 12, in an example.

### DETAILED DESCRIPTION

The same reference numbers or other reference designators are used in the drawings to designate the same or similar (either by function and/or structure) features.

As noted above, PWM dimming regulates the output current to the LEDs by chopping the current based on a PWM signal. At lower PWM frequencies, a high-speed camera pointed at the LEDs may exhibit flickering due to the LEDs turning on and off. Further, at lower PWM frequencies, an audible noise may be generated, for example, by a capacitor included within or coupled to the LED driver. Using PWM frequencies greater than, for example, 20 KHz may avoid such flickering and audible noise problems. However, at PWM frequencies greater than 20 KHz, contrast ratios for conventional LED drivers greater than, for example, 1000:1 are difficult, if not impossible, to achieve.

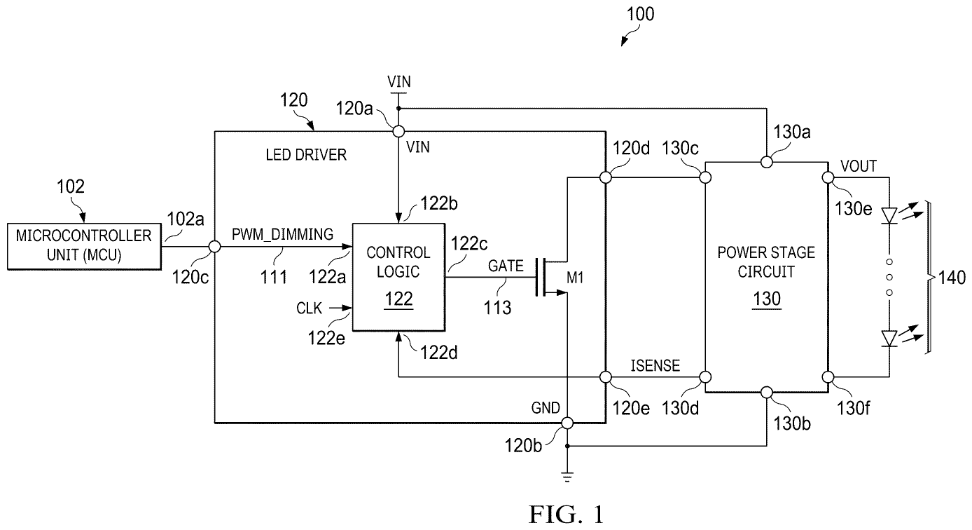

FIG. 1 is a diagram of a system 100 which includes a microcontroller unit (MCU) 102, an LED driver 120, a power stage circuit 130, and one or more LEDs 140. LED driver 120 may be fabricated as an integrated circuit (IC). In one example, power stage circuit 130 may be separate from the IC containing LED driver 120. In another example, power stage circuit 130 may be packaged together with LED driver 120, e.g., on the same IC containing the LED driver.

In one example, MCU 102 may include a processor that executes machine instructions stored therein or in memory otherwise accessible to the processor. MCU 102 has an output 102a that is coupled to a terminal 120c of LED driver 120. LED driver 120 also has terminals 120a, 120b, 120d, and 120e. Terminals 120a and 120b are power supply terminals coupled to an input voltage VIN and ground, respectively. Terminals 120d and 120e are coupled to terminals 130c and 130d of power stage circuit 130, respectively. Terminal 120d is a switching terminal. Terminal 130d of power stage circuit 130 is a current sensing terminal which provides a signal ISENSE (e.g., a voltage) indicative of the current through an inductor of the power stage circuit (described below). Power stage circuit 130 also has terminals 130e and 130f. Power stage circuit 130 generates an output voltage VOUT at its terminal 130e. One or more LEDs 140 can be coupled in series between terminals 130e and 130f. Power stage circuit 130 also has terminals 130a and 130b, which are coupled to the input voltage VIN and ground, respectively.

MCU 102 generates an output PWM_DIMMING signal 111 to terminal 120c of LED driver 120. In response to the PWM_DIMMING signal being, for example, logic high, LED driver 120 turns on LEDs 140. In response to the PWM_DIMMING signal being, for example, logic low, LED driver 120 turns off LEDs 140. The frequency of the PWM_DIMMING signal is high enough (e.g., greater than at least 100 Hz) that, to humans, the light from LEDs 140 appears to be continuous (i.e., not flickering as the LEDs are repeatedly turned on and off).

LED driver 120 includes control logic 122 and a transistor M1. Control logic 122 may be implemented as a logic circuit, examples of which are provided below. In this example, transistor M1 is an n-channel field effect transistor (NFET) having transistor terminals (e.g., a source and a drain) and a control terminal (e.g., a gate). Control logic 122 has inputs 122a, 122b, 122d, and 122e and an output 122c. Input 122a is coupled to terminal 120c (e.g., a PWM dimming terminal) of LED driver 120 and receives the PWM_DIMMING signal 111 from MCU 102. Input 122b is coupled to terminal 120a and receives the input voltage VIN. Output 122c is coupled to the gate of transistor M1 and provides a gate voltage (GATE) 113 to the transistor's gate. Input 122d is coupled to terminal 120e. A clock (CLK) (e.g., generated by an oscillator within LED driver 120) is provided to input 122e of control logic 122. In one example, control logic 122 includes a peak current mode switching converter controller in which control logic 122 turns on (closed state) transistor M1 in response to an edge (e.g., a rising edge) of CLK and turns off transistor M1 (open state) when the current through an inductor of power stage circuit 130 reaches a peak current reference level. In response to a logic high of the PWM signal, control logic 122 may assert the GATE voltage 113 to a logic high state to turn on transistor M1, then switch transistor M1 on and off based on CLK while the PWM signal remains logic high. Control logic 122 may force the GATE voltage 113 logic low to turn off transistor M1 when the PWM signal becomes logic low.

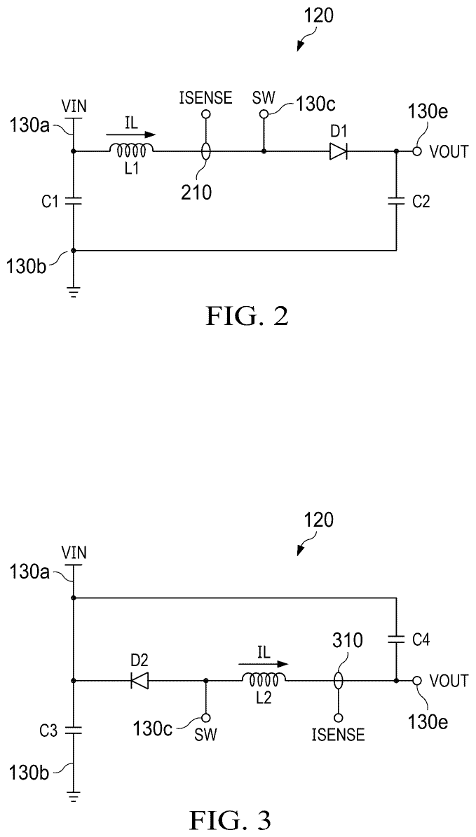

FIGS. 2 and 3 are schematic diagrams of examples of power stage circuit 130. The example of FIG. 2 is that of a power stage for a boost converter or a buck-boost converter. In FIG. 2, power stage circuit 130 includes an inductor L1, a diode D1, capacitors C1 and C2, and a current sense circuit 210. Capacitor C1 and inductor L1 are coupled to terminal 130a (VIN). Current sense circuit 210 is coupled to inductor L1 and generates signal ISENSE indicative of the current IL through the inductor. The anode of diode D1 is coupled to inductor L1 (e.g., via current sense circuit 210) and to terminal 130c. One terminal of capacitor C2 is coupled to the cathode of diode D1 and to terminal 130e (VOUT). The other terminal of capacitor C2 is coupled to capacitor C1 and to ground.

The example of FIG. 3 is that of a power stage for a buck converter. In FIG. 3, power stage circuit 130 includes an inductor L2, a diode D2, capacitors C3 and C4, and a current sense circuit 310. Capacitor C3 and the cathode of diode D2 are coupled together and to terminal 130a (VIN). Inductor L2 is coupled between the anode of diode D2 and terminal 130e via, for example, current sense circuit 310. The anode of diode D2 is coupled to terminal 130c. Current sense circuit 310 generates signal ISENSE indicative of the current IL through inductor L2. Capacitor C4 is coupled between terminal 130a and 130e.

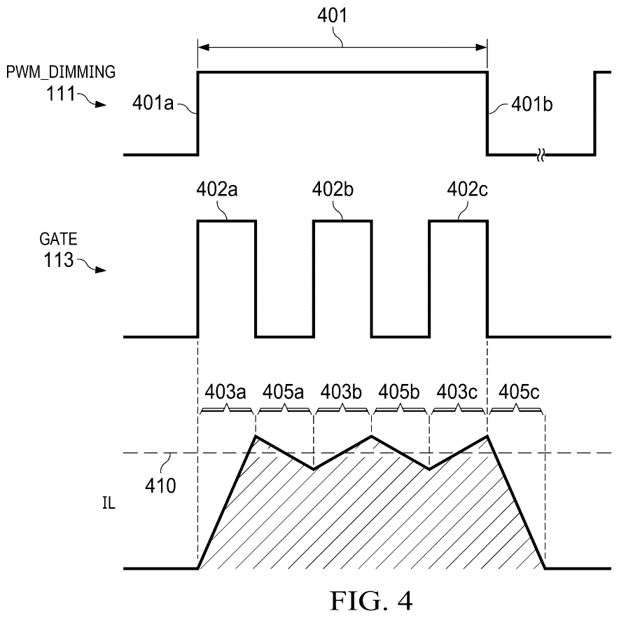

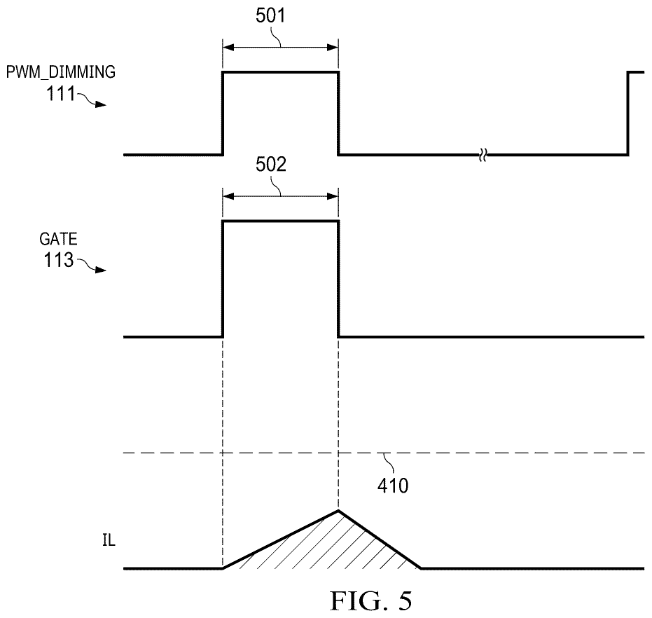

FIGS. 4 and 5 include sample waveforms of the PWM_DIMMING signal 111, the GATE voltage 113, and inductor current IL illustrating the problem solved by the LED driver 120 described herein. While the PWM_DIMMING signal 111 is logic high, as indicated by 401, control logic 122 turns transistor M1 on and off at a substantially higher frequency than the frequency of the PWM_DIMMING signal 111. For example, the frequency at which transistor M1 is turned on and off may be 400 KHz while the frequency of the PWM_DIMMING signal 111 is 20 KHz (or higher). Only three pulses 402a, 402b, and 402c are illustrated for the GATE voltage 113 for simplicity, control logic 122 produces many more than three pulses for GATE voltage 113 for each positive pulse 401 of the PWM_DIMMING signal 111. Each time the GATE voltage 113 is logic high, transistor M1 turns on and the current IL rises as identified at 403a, 403b, and 403c. Each time the GATE voltage 113 is logic low, transistor M1 turns off and the current IL decreases as identified at 405a, 405b, and 405c.

When the PWM_DIMMING signal 111 transitions from logic low to logic high (rising edge 401a), current through inductor L1 is approximately 0 amperes. Accordingly, one or more switching cycles of the GATE voltage 113 are required for the inductor current IL to reach its target level 410. From that point on, the current IL remains at the target level 410, with ripple due to the switching behavior of control logic 122 (e.g., as transistor M1 is turned on and off as explained above). When the falling edge 401b occurs, the inductor IL falls back to approximately 0 amperes. The PWM_DIMMING signal 111 is logic high (401) long enough to allow control logic 122 to achieve regulation of its current IL

FIG. 5 is an example in which the duty cycle of the PWM_DIMMING signal 111 for a conventional LED driver is small enough that the length of time 501 that the PWM signal is logic high is short enough that only a single pulse of the GATE voltage 113 occurs. The length of time 502 of the single gate pulse is short enough that the inductor IL does not have enough time to rise to its target level 410 before transistor M1 turns off thereby causing the inductor current IL to return to 0 amperes. In FIG. 5, the PWM_DIMMING signal 111 is not logic high long enough for control logic 122 is achieve regulation of its current IL. The amount of charge delivered to the LEDs 140 is proportional to the product of the level of current IL and the time period over which the current persists. Because transistor M1 is turned off before control current IL reaches its target level 410, the amount of charge provided to LEDs 140 is less than a desired charge level—the desired charge level being the target current level 410 times the length of time 502.

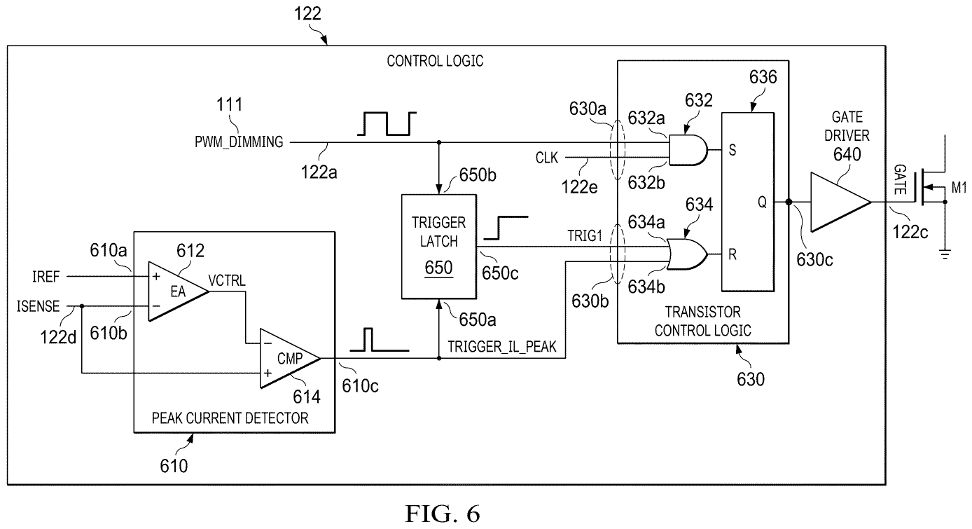

FIG. 6 is a schematic diagram of an example implementation of control logic 122. As described above, for a conventional LED driver, the duty cycle of the PWM_DIMMING signal 111 may be small enough that the inductor current IL does not reach the peak current reference for the peak current mode switching converter implemented within control logic 122. In the example of FIG. 6, control logic 122 implements pulse width modulation extension by which transistor M1 is maintained on even after the PWM_DIMMING signal 111 becomes logic low if the inductor current IL has not yet reached the peak current reference. Control logic 122 turns transistor M1 off when both the PWM_DIMMING signal 111 becomes logic low and the inductor current IL has reached the peak current reference at least once after the PWM_DIMMING signal 111 previously became logic high.

In the example of FIG. 6, control logic 122 includes a peak current detector 610, transistor control logic 630, a gate driver 640, and a trigger latch 650. Peak current detector 610 has a reference input 610a, a sense input 610b, and an output 610c. Transistor logic control logic 630 has an input 630a, an input 630b, and an output 630c. Trigger latch 650 has inputs 650a and 650b and an output 650c. A peak current reference signal IREF, e.g., generated by a reference current circuit, is provided to input 610a of peak current detector 610. Input 610b receives the signal ISENSE from power stage circuit 130. Peak current detector 610 includes an error amplifier (EA) 612 and a comparator 614. The positive (+) input of EA 612 is coupled to input 610a, and the negative (−) input of EA 612 is coupled to input 610b. EA generates a signal VCTRL at its output based on the difference between IREF and ISENSE. The output of EA 612 is coupled to the negative input of comparator 614, and input 610b is coupled to the positive input of comparator 614. Comparator 614 generates a digital signal TRIGGER_IL_PEAK at its output. In the example of FIG. 6, comparator 614 forces signal TRIGGER_IL_PEAK to a logic high level when signal ISENSE reaches the peak current reference signal IREF; otherwise, comparator 614 forces signal TRIGGER_IL_PEAK to a logic low level.

The output 610c of peak current detector 610 is coupled to input 630b of transistor control logic 630. Input 122e of control logic 122 is coupled to input 630a of transistor control logic 630. The output 630c of control logic 630 is coupled to an input of gate driver 640, and the output of gate driver 640 is coupled to the output 122c of control logic 122. Transistor control logic 630 includes an AND gate 632, an OR gate 634, and a set(S)-reset (R) latch 636. In this example, each of inputs 630a and 630b include two signal inputs. For example, input 630a has two inputs that couple to inputs 632a and 632b of AND gate 632. Similarly, input 630b has two inputs that couple to inputs 634a and 634b of OR gate 634. Output 610c of peak current detector 610 is coupled to input 634b of OR gate 634, and output 650c of trigger latch 650 is coupled to input 634a of OR gate 634. Trigger latch 650 generates a signal TRIG1 at its output 650c. The PWM_DIMMING signal 111 and CLK are provided to inputs 632a and 632b, respectively, of AND gate 632. The output of AND gate 632 is coupled to the set input of SR latch 636, and the output of OR gate 634 is coupled to the reset input of SR latch 636. The Q output of SR latch 636 is coupled to the output 630c of transistor control logic 630 and, accordingly, to the input of gate driver 640.

SR latch 636 is set when both CLK and PWM_DIMMING signal 111 are logic high. SR latch 636 is reset when either or both of signals TRIG1 or TRIGGER_IL_PEAK are logic high. When SR latch 636 is set, its Q output becomes logic high, which through gate driver 640, causes transistor M1 to turn on. When SR latch 636 is reset, its Q output becomes logic low which causes transistor M1 to turn off. Trigger latch 650 forces signal TRIG1 logic high when the following conditions are both true: (1) the PWM_DIMMING signal 111 is logic low and (2) signal TRIGGER_IL_PEAK is logic high. In other words, trigger latch 650 forces TRIG1 logic high when MCU 102 has turned off PWM dimming (e.g., the PWM_DIMMING signal 111 is logic low) and peak current detector 610 has detected that the inductor current IL has reached the peak current reference IREF. If PWM dimming has been turned off (PWM_DIMMING signal 111 is logic low) but inductor current IL has not yet reached the peak current reference, trigger latch 650 maintains TRIG1 at a logic low level. Accordingly, SR latch 636 does not reset and transistor M1 does not turn off following the PWM_DIMMING signal 111 becomes logic low until the inductor current IL has also reached the peak current reference IREF. OR gate 634 logically ORs TRIG1 and TRIGGER_IL_PEAK. In addition to SR latch 636 resetting in response to PWM dimming turning off and inductor current IL reaching the peak current reference, SR latch 636 also resets each time the inductor current IL reaches the peak current reference when PWM dimming is on (e.g., the PWM_DIMMING signal 111 is logic high).

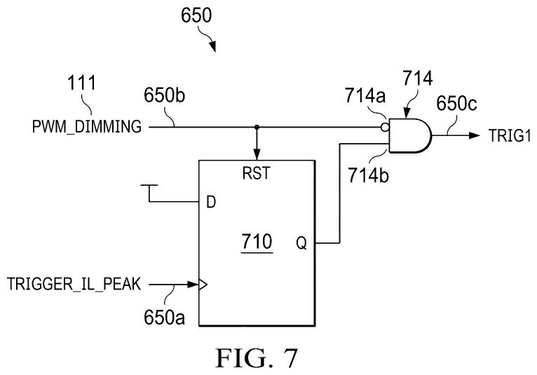

FIG. 7 is a schematic diagram of an implementation of trigger latch 650 in the example of FIG. 6. In FIG. 7, trigger latch 650 includes a D flip-flop (DFF) 710 and an AND gate 714. The DFF 710 has a reset (RST) input, a data (D) input, a clock input, and a Q output. AND gate 714 has inputs 714a and 714b. Input 714a is an inverted input (e.g., opposite polarity of input 714b). Input 650b (which provides the PWM_DIMMING signal 111) is coupled to the reset input of DFF 710 and to input 714a of AND gate 714. The Q output of DFF 710 is coupled to the input 714b of AND gate 714. The D input of DFF 710 is tied logic high. The input 650a (which provides the TRIGGER_IL_PEAK signal) is coupled to the clock input of DFF 710. The output of AND gate 714 is coupled to the output 650c and provides the TRIG1 signal. TRIGGER_IL_PEAK transitioning from logic low to logic high (a rising edge) clocks DFF 710 thereby forcing its Q output to a logic high state. Accordingly, input 714b of AND gate 714 is logic high. AND gate 714 forces TRIG1 logic high when both PWM_DIMMING 111 is logic low and the Q output of DFF 710 is logic high.

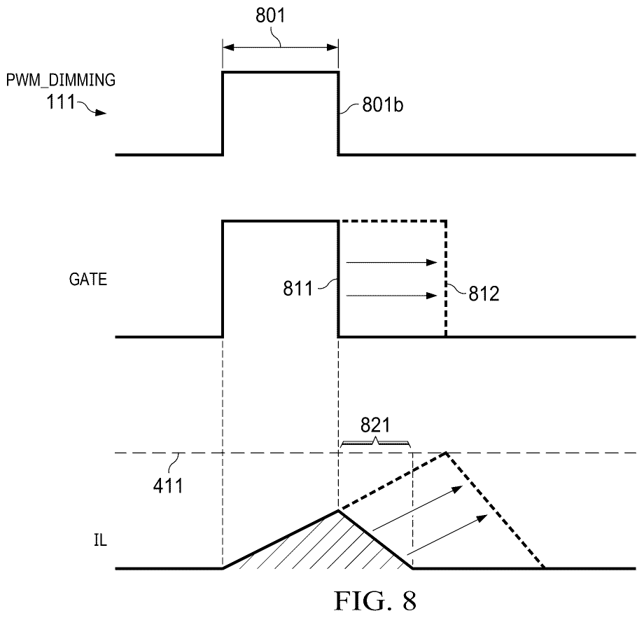

FIG. 8 includes waveforms illustrating the PWM extension functionality of control logic 122. With a conventional LED driver, the width 801 of PWM_DIMMING 111 is small enough that transistor M1 would turn off at falling edge 801b of PWM_DIMMING 111, as also indicated by falling edge 811 of GATE, which represents an example signal at 122c received by the gate of M1. Transistor M1 would therefore not be on long enough to allow the inductor current IL to reach its target level 411 before decreasing back to 0 amperes as identified at 821. However, the PWM extension functionality of control logic 122 in FIGS. 6 and 7 causes transistor M1 to remain on passed falling edge 801b. The falling edge of GATE 812 is extended to allow transistor M1 to remain on long enough to allow inductor current IL to reach its target level commensurate with the peak current reference IREF before then turning off.

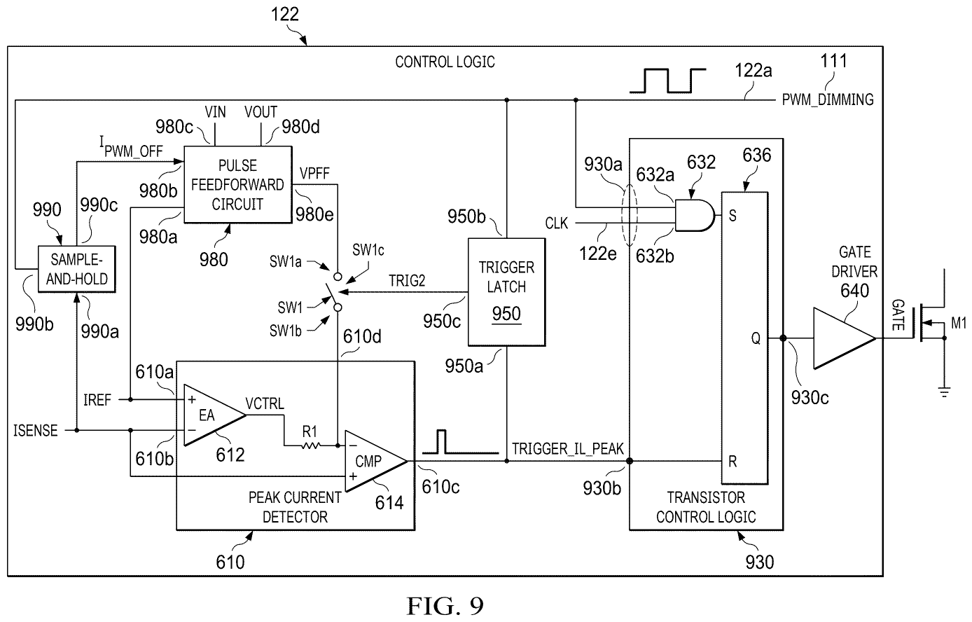

FIG. 9 is a schematic diagram of another example implementation of control logic 122. Control logic 122 in FIG. 9 controls the transient response (e.g., makes the transient response faster) of the LED driver 120 due to a sudden change in duty cycle of the PWM_DIMMING signal 111. Control logic 122 in FIG. 9 lacks the PWM extension functionality of control logic 122 in FIG. 6. Control logic 122 in this example includes peak current detector 610, transistor control logic 930, gate driver 640, a trigger latch 950, a switch SW1, a pulse feedforward circuit 980, and a sample-and-hold (S/H) 990. Peak current detector 610 has been described previously. Transient control logic 930 is similar to transient control logic 630 in FIG. 6 and includes AND gate 632 and SR latch 636 but lacks OR gate 634. Instead of OR gate 634, the output 610c of peak current detector 610 is coupled to the reset input of SR latch 636.

Trigger latch 950 has inputs 950a and 950b and an output 950c. Switch SW1 has switch terminals SW1a and SW1b and a control terminal SW1c. Pulse feedforward circuit 980 has inputs 980a, 980b, 980c, and 980d and an output 980e. Input 980a is coupled to input 610a of peak current detector 610 and, accordingly, receives peak current reference signal IREF. The S/H 990 has inputs 990a and 990b and an output 990c. The input 990a is coupled to input 610b of peak current detector 610 and receives signal ISENSE. The input 990b receives the PWM_DIMMING signal 111. The output 990c is coupled to input 980b of pulse feedforward circuit 980. The S/H 990 samples the signal ISENSE upon a falling edge of the PWM_DIMMING signal 111 as current IPWM_OFF. Accordingly, current IPWM_OFF is indicative of (e.g., proportional to) the inductor current IL when PWM dimming is turned off. Inputs 980c and 980d of pulse feedforward circuit 980 receive input voltage VIN and output voltage VOUT, respectively. The output 980e of pulse feedforward circuit 980 is coupled to a switch terminal SW1a of switch SW1. Pulse feedforward circuit 980 determines VPFF at its output 980e. The opposing switch terminal SW1b is coupled to an input 610d of peak current detector 610. Peak current detector 610 in FIG. 9 includes a resistor coupled between the output of EA 612 and the negative input of comparator 614. Input 610d is coupled to the connection between resistor R1 and the negative input of comparator 614. The output 950c of trigger latch 950 is coupled to a control terminal SW1c of switch SW1. Input 950b of trigger latch 950 receives the PWM_DIMMING signal 111. Input 950a of trigger latch 950 is coupled to the output 610c of peak current detector 610.

In FIG. 9, trigger latch 950 detects when both: (1) PWM dimming has been turned off (e.g., PWM_DIMMING is logic low) and (2) the inductor current IL has not yet reached the peak current reference IREF (e.g., TRIGGER_IL_PEAK also is logic low). When both of the above conditions (1) and (2) are met, trigger latch 950 asserts a signal TRIG2 at its output 950c to, for example, a logic high state; otherwise, trigger latch 950 forces signal TRIG2 to a logic low state. In response to TRIG2 being logic high, switch SW1 closes and voltage VPFF is provided to the negative input of comparator 614 instead of VCTRL from EA 612. By forcing the negative input of comparator 614 to have voltage VPFF instead of VCTRL from EA 612, the control logic 122 responds more quickly to a sudden change in duty cycle of the PWM_DIMMING signal 111.

Pulse feedforward circuit 980 generates a current IPFF in accordance with the following equation:

$${IPFF}^{2} = 2 * IREF * {IPWM}_{OFF} * \frac{max ( V IN , V OUT ) - min ( V IN , V OUT )}{max ( V in , V OUT )} \qquad ( Eq . 1 )$$

Pulse feedforward circuit 980 generates the voltage VPFF based on current IPFF, for example, by passing current IPFF through a resistor to generate the voltage VPFF. Current IPFF is the inductor current IL that should be reached to provide an amount of charge to the LEDs during PWM dimming to equal the charge of an ideal case in which the inductor current IL has infinite slope (e.g., does not ramp up/down as a function of inductance and voltage) and is at the peak reference current level for the entirety of the PWM dimming on state.

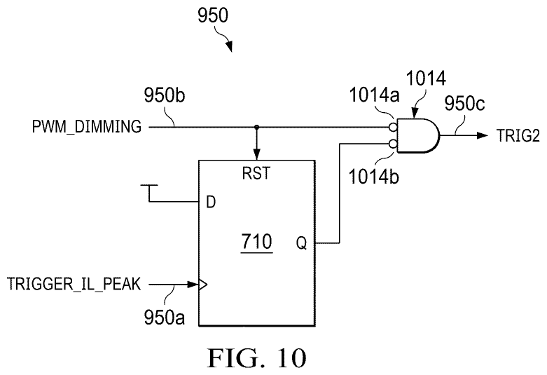

FIG. 10 is a schematic diagram of an implementation of trigger latch 950 in the example of FIG. 9. In FIG. 10, trigger latch 950 includes DFF 710 and an AND gate 1014. AND gate 1014 has inputs 1014a and 1014b. Inputs 1014a and 1014b are inverted inputs. Input 950b (which provides the PWM_DIMMING signal 111) is coupled to the reset input of DFF 710 and to input 1014a of AND gate 1014. The Q output of DFF 710 is coupled to the input 1014b of AND gate 1014. The D input of DFF 710 is tied logic high. The input 950a (which provides the TRIGGER_IL_PEAK signal) is coupled to the clock input of DFF 710. The output of AND gate 1014 is coupled to the output 950c and provides the TRIG2 signal. TRIGGER_IL_PEAK transitioning from logic low to logic high (a rising edge) clocks DFF 710 thereby forcing its Q output to a logic high state; otherwise, if a rising edge is not present for TRIGGER_IL_PEAK, the Q output remains logic low. Accordingly, if both inputs 1014a and 1014b of AND gate 1014 are logic low, AND gate 1014 forces TRIG2 logic high. Alternatively stated, TRIG2 is forced logic high when PWM dimming is off and TRIGGER_IL_PEAK has not yet been forced high.

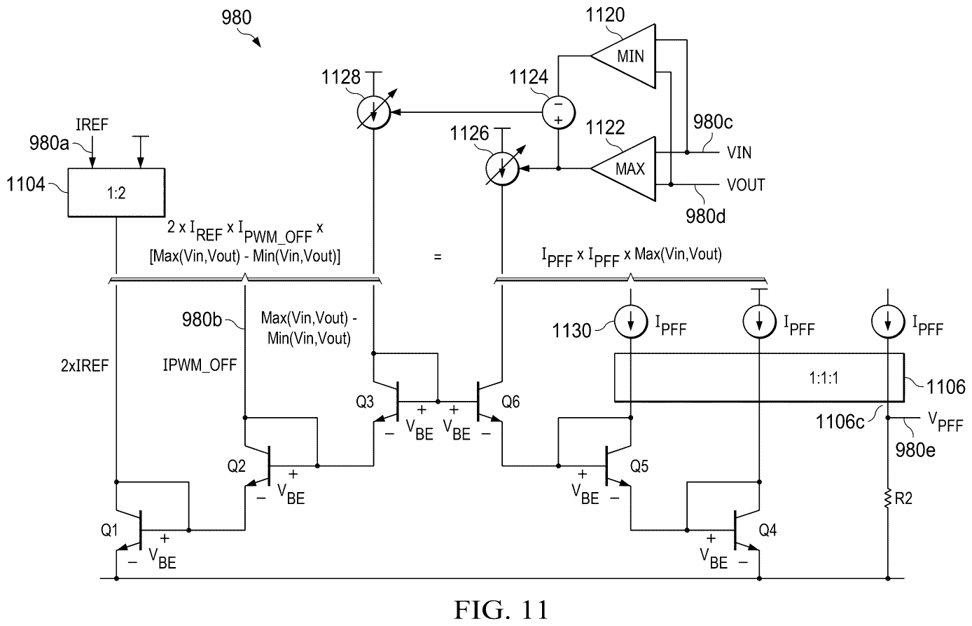

FIG. 11 is a circuit schematic illustrating an example implementation of pulse feedforward circuit 980. The example pulse feedforward circuit of FIG. 11 is an analog circuit based on bipolar junction transistors (BJTs) that implement Eq. (1) above. In other examples, pulse feedforward circuit can be implemented by a processor executing machine instructions (e.g., a microcontroller). In the example of FIG. 11, pulse feedforward circuit 980 includes transistors Q1, Q2, Q3, Q4, Q5, and Q6 (e.g., NPN BJTs), resistor R2, current mirrors 1104 and 1106, comparators 1120 and 1122, subtractor 1124, voltage-controlled current sources 1126 and 1128, and a current source 1130. The collector of each transistor Q1-Q6 is coupled to its respective base. The emitters of transistors Q1 and Q4 are coupled together. The base of transistor Q1 is coupled to the emitter of transistor Q2, and the base of transistor Q2 is coupled to the emitter of transistor Q3. The bases of transistors Q3 and Q6 are coupled together. The emitter of transistor Q6 is coupled to the base of transistor Q5, and the emitter of transistor Q5 is coupled to the base of transistor Q4.

Current mirror 1104 has an input that is coupled to input 980a and receives peak current reference signal IREF. The mirror ratio for current mirror 1104 is 1:2 and, accordingly, the output current from current mirror 1104 is 2×IREF, which is provided to the collector of transistor Q1. The collector of transistor Q2 is coupled to input 980b and receives current IPWM_OFF.

Comparators 1120 and 1122 are voltage comparators. Each comparator 1120 and 1122 receive voltages VIN and VOUT as their inputs. Comparator 1120 outputs the minimum (min(VIN,VOUT)) between VIN and VOUT as its output voltage to an input of subtractor 1124. Comparator 1122 outputs the maximum between VIN and VOUT (max(VIN,VOUT)) as its output voltage to another input of subtractor 1124. Subtractor 1124 subtracts the output voltage of comparator 1120 from the output voltage from comparator 1122 and proves an output voltage (max(VIN,VOUT)−min(VIN,VOUT)) to a control input of voltage-controlled current source 1128. The current produced by voltage-controlled current source 1128 is a current proportional to max(VIN, VOUT)−min(VIN,VOUT), which is provided to the collector of transistor Q3. Current source 1130 is coupled to an input of current mirror 1106 which mirrors the current IPFF from current source 1130 to the collectors of transistors Q5 and Q6. The mirror ratio of current mirror 1106 is 1:1:1. The current from output 1106c of current mirror 1106 is coupled to resistor R2, which converts the current IPFF from current mirror 1106 to the corresponding voltage VPFF at output 980e.

The sum of the base-to-emitter voltages (Vbe) of transistors Q1-Q3 equals the sum of the Vbe's of transistors Q4-Q6. Because of the exponential relationship between collector current and Vbe of BJTs, the sum of the Vbe's of transistors Q1-Q3 is equal to 2*IREF*[max(VIN,VOUT)−min(VIN, VOUT)], and the sum of the Vbe's of transistors Q4-Q6 is equal to IPFF*IPFF*max(VIN,VOUT). Current source 1130 generates a current IPFF that causes the sum of the Vbe's of transistors Q1-Q3 to equal the sum of the Vbe's of transistors Q4-Q6. Accordingly, the circuit of FIG. 11 implements Eq. (1) above.

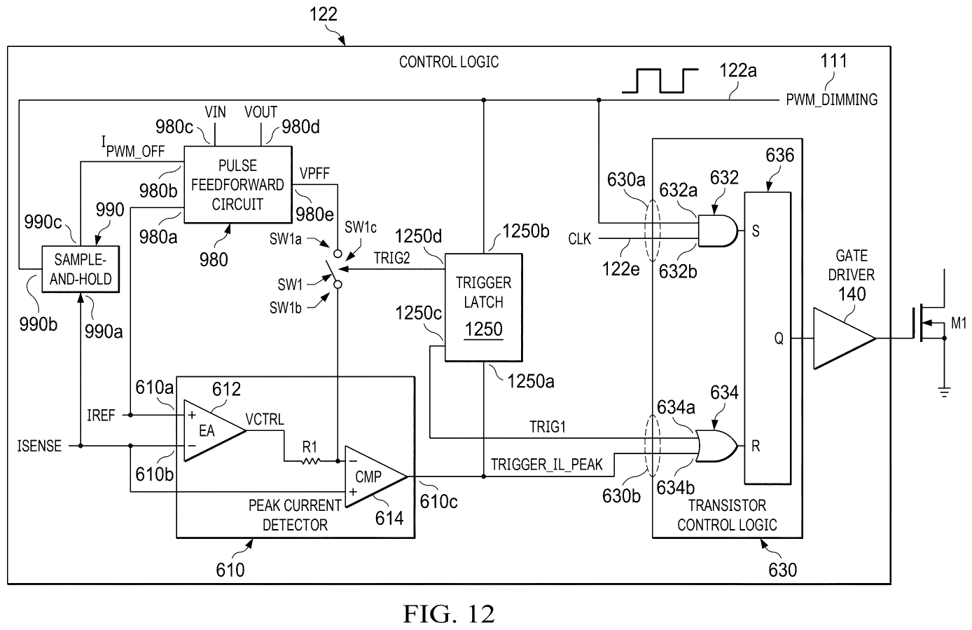

FIG. 12 is a schematic diagram of another example of control logic 122 which incorporates both PWM extension and pulse feedforward. Accordingly, control logic 122 in the example of FIG. 12 includes a trigger latch 1250 that generates both the TRIG1 and TRIG2 signals, described above. Control logic 122 in FIG. 12 also includes peak current detector 610, transistor control logic 630 (of FIG. 6), pulse feedforward circuit 980 and switch SW1 (FIG. 9), components whose descriptions are provided above. Trigger latch 1250 can assert TRIG1 logic high to ensure that transistor M1 remains on even after PWM dimming turns off until the inductor current IL reaches the peak current reference signal IREF. Trigger latch 125 also can assert TRIG2 logic high to when PWM dimming turns off if inductor current IL has not reached the peak current reference signal IREF to improve the transient response as described above.

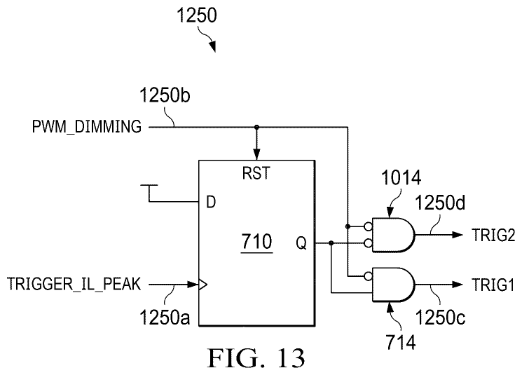

FIG. 13 is a schematic diagram of trigger latch 1250. Trigger latch 1250 is similar to the trigger latches of FIGS. 7 and 10 and includes DFF 710, AND gate 714 (of FIG. 7), and AND gate 1014 (of FIG. 10). The operation of DFF 710 and AND gate 714 in FIG. 13 to generate TRIG1 is as described above regarding FIG. 7. Similarly, the operation of DFF 710 and AND gate 1014 in FIG. 13 to generate TRIG2 is as described above regarding FIG. 10.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a transistor having a control terminal;
transistor control logic having a first input, a second input, and an output, the output coupled to the control terminal of the transistor;
a peak current detector having a reference input, a sense input, and an output, the peak current detector configured to assert a first signal at the output of the peak current detector at a first logic state in response to a sense signal at the sense input exceeding a reference signal at the reference input; and
a trigger latch having a first input, a second input, and an output, the first input of the trigger latch coupled to the output of the peak current detector, and the output of the trigger latch coupled to the first input of the transistor control logic, the trigger latch configured to assert a third signal at the first logic state at the output of the trigger latch in response to both the first signal at the output of the peak current detector being at the first logic state and a second signal at the second input of the trigger latch being at a second logic state.

2. The apparatus of claim 1, wherein the output of the trigger latch is a first output, the trigger latch has a second output, the peak current detector has a second input and a third input, and the apparatus further comprises:
a pulse feedforward circuit having a first input and an output, the first input coupled to the second input of the peak current detector; and
a switch having first and second switch terminals and a control terminal, the first switch terminal coupled to the output of the pulse feedforward circuit, the second switch terminal coupled to the third input of the peak current detector, and the control terminal of the switch coupled to the second output of the trigger latch.

3. The apparatus of claim 2, wherein the pulse feedforward circuit is configured to determine a fourth signal at the output of the pulse feedforward circuit based on a reference signal at the first input of the pulse feedforward circuit.

4. The apparatus of claim 2, wherein the pulse feedforward circuit has a second input and a third input, and the pulse feedforward circuit is configured to determine a fourth signal at the output of the pulse feedforward circuit based on one of a signal or a voltage at the respective first, second, and third inputs of the pulse feedforward circuit.

5. The apparatus of claim 2, wherein the trigger latch is configured to assert a signal at the second output of the trigger latch to cause the switch to be in a closed state in response to the first signal at the output of the peak current detector being at the second logic state and the second signal at the second input of the trigger latch being at the second logic state.

6. The apparatus of claim 1, wherein the trigger latch includes:
a data (D) flip-flop having a clock input, a reset input, and an output, the clock input coupled to the first input of the trigger latch, the reset input coupled to the second input of the trigger latch; and
an AND gate having a first input, a second input, and an output, the first input of the AND gate coupled to the output of the D flip-flop, the second input of the AND gate coupled to the second input of the trigger latch, and the output of the AND gate coupled to the output of the trigger latch.

7. The apparatus of claim 1, wherein the transistor has a transistor terminal, the apparatus further comprises:
a power stage having an input and an output, the input of the power stage coupled to the transistor terminal; and
a light emitting diode having a terminal coupled to the output of the power stage.

8. The apparatus of claim 1, wherein the apparatus has a pulse width modulation (PWM) dimming terminal, and the second input of the trigger latch is coupled to the PWM dimming terminal.

9. An apparatus, comprising:
a trigger latch having a first input, a second input, and an output, the trigger latch configured to assert a first signal at a first logic state at the output of the trigger latch in response to both a second signal at the first input of the trigger latch being at a second logic state and a third signal at the second input of the trigger latch being at the second logic state;
a pulse feedforward circuit having an output;
an error amplifier having first and second inputs and an output;
a switch having a first switch terminal, a second switch terminal, and a control terminal, the first switch terminal coupled to the output of the pulse feedforward circuit, the second switch terminal coupled to the output of the error amplifier, and the control terminal of the switch coupled to the output of the pulse feedforward circuit; and
a comparator having a first input, a second input, and an output, the first input of the comparator coupled to the second switch terminal, the second input of the comparator coupled to the second input of the error amplifier, and the output of the comparator coupled to the first input of the trigger latch.

10. The apparatus of claim 9, wherein the pulse feedforward circuit has an input coupled to the second input of the error amplifier, and the pulse feedforward circuit is configured to generate a signal at the output of the pulse feedforward circuit based on a signal at the input of the pulse feedforward circuit.

11. The apparatus of claim 9, wherein the pulse feedforward circuit has a first input and a second input, the first input of the pulse feedforward circuit coupled to the second input of the error amplifier, and the pulse feedforward circuit is configured to generate a signal at the output of the pulse feedforward circuit based on a signal at the first input of the pulse feedforward circuit and a voltage at the second input of the pulse feedforward circuit.

12. The apparatus of claim 9, wherein the pulse feedforward circuit has a first input and a second input, the first input of the pulse feedforward circuit coupled to the second input of the error amplifier, and the pulse feedforward circuit is configured to generate a signal at the output of the pulse feedforward circuit based on a product of a signal at the first input of the pulse feedforward circuit and a signal at the second input of the pulse feedforward circuit.

13. The apparatus of claim 9, wherein the pulse feedforward circuit has a first input, a second input, and a third input, the first input of the pulse feedforward circuit coupled to the second input of the error amplifier, and the pulse feedforward circuit is configured to generate a signal at the output of the pulse feedforward circuit based on a signal at the first input of the pulse feedforward circuit, a first voltage at the second input of the pulse feedforward circuit, and a second voltage at the third input of the pulse feedforward circuit.

14. The apparatus of claim 9, wherein the switch is configured to close in response to the first signal at the output of the trigger latch being at the first logic state.

15. The apparatus of claim 9, wherein the output of the trigger latch is a first output and the trigger latch has a second output, and the apparatus further comprises:
transistor control logic having a first input and a second input, the first input of the transistor control logic coupled to the second input of the trigger latch, the second input of the transistor control logic coupled to first input of the trigger latch, the trigger latch configured to assert a fourth signal at the first logic state at the second output of the trigger latch in response to both the second signal at the first input of the trigger latch being at the first logic state and the third signal at the second input of the trigger latch being at the second logic state.

16. An apparatus, comprising:
a transistor having a control terminal;
a transistor control logic having a first input, a second input, and an output, the output coupled to the control terminal of the transistor;
a peak current detector having a reference input, a sense input, a third input, and an output, the peak current detector configured to assert a first signal at the output of the peak current detector at a first logic state in response to a sense signal at the sense input exceeding a reference signal at the reference input;
a pulse feedforward circuit having an input and an output, the input of the pulse feedforward circuit coupled to the reference input of the peak current detector;
a switch having a first switch terminal, a second switch terminal, and a control terminal, the first switch terminal coupled to the output of the pulse feedforward circuit, the second switch terminal coupled to the third input; and
a trigger latch having a first input, a second input, a first output, and a second output, the first input of the trigger latch coupled to the output of the peak current detector, the first output of the trigger latch coupled to the first input of the transistor control logic, the second output of the trigger latch coupled to the control terminal of the switch, the trigger latch configured to assert a second signal at the first logic state at the first output of the trigger latch in response to both the first signal at the output of the peak current detector being at the first logic state and a third signal at the second input of the trigger latch being at a second logic state.

17. The apparatus of claim 16, wherein the trigger latch is configured to assert a fourth signal at the first logic state at the second output of the trigger latch in response to both the first signal at the output of the peak current detector being at the second logic state and the third signal at the second input of the trigger latch being at the second logic state.

18. The apparatus of claim 16, wherein the trigger latch includes:
a data (D) flip-flop having a clock input, a reset input, and an output;
a first AND gate having a first input, a second input, and an output, the first input of the first AND gate coupled to the second input of the trigger latch, the second input of the first AND gate coupled to output of the D flip-flop, and the output of first AND gate coupled to the second output of the trigger latch; and
a second AND gate having a first input, a second input, and an output, the first input of the second AND gate coupled to the second input of the trigger latch, the second input of the second AND gate coupled to output of the D flip-flop, and the output of second AND gate coupled to the second output of the trigger latch.

19. The apparatus of claim 18, wherein the second input of the first AND gate is of opposite polarity as the second input of the second AND gate.

20. The apparatus of claim 18, wherein the input of the pulse feedforward circuit is a first input, the pulse feedforward circuit has a second input and an third input, and the pulse feedforward circuit is configured to generate a signal at the output of the pulse feedforward circuit based on one of a signal or a voltage at the respective first, second, and third inputs of the pulse feedforward circuit.
